(19) United States
(12) Patent Application Publication
(10) Pub. No.: US 2017/0373518 A1
(43) Pub. Date: Dec. 28, 2017

(54) CASE FOR AN ELECTRONIC DEVICE

(71) Applicant: Mark Hadnett, White Plains, NY (US)

(72) Inventor: Mark Hadnett, White Plains, NY (US)

(21) Appl. No.: 15/626,093

(22) Filed: Jun. 17, 2017

Related U.S. Application Data
(60) Provisional application No. 62/354,693, filed on Jun. 25, 2016.

(51) Int. Cl. H02J 7/00; H02J 7/02; H01R 13/642; H01R 33/06; H04M 1/02; H04B 1/3827

(52) U.S. Cl. CPC H02J 7/0052; H04M 1/0262; H04B 1/3833; H01R 13/642; H02J 7/0042; H01R 33/06; H02J 7/025

(57) ABSTRACT

Disclosed is a case for an electronic device. The case for the electronic device includes an integrated electronic device charger adapted for charging the electronic device in wireless manner using an integrated sensor adapted to actuate charging of the electronic device when the electronic device reaches below a predefined battery threshold, an auxiliary battery adapted for provided additional power supply to the electronic device, and a charging port adapted for charging the electronic device through external power.

### CROSS-REFERENCE TO RELATED APPLICATION

The present application is related to U.S. provisional patent application No. 62/354,693, filed on Jun. 25, 2016. The entire disclosure of the above patent application is hereby incorporated by reference.

### FIELD OF THE INVENTION

The present application generally relates to the field of enclosure for electronic device and wireless charging. Particularly, the application provides a case for an electronic device. More particularly, the application provides a case for an electronic device adapted for charging the electronic device in wireless manner.

### BACKGROUND

In the recent past mobile communication devices has taken an irreplaceable place in day to day of human life. With the advent of modern communication technology energy consumed per mobile communication device has also increased consequently by several folds. The increased use of mobile communication devices have brought in phenomenal improvement in human life, however it also have impacted pattern of energy consumed by such devices. Thereby mobile communication devices have to be charged consistently to avail communication services.

There have been several attempts to replace previously used wired charging of mobile communication devices with advance wireless charging of mobile communication devices for eliminating typical problems confronted by wired charging. Prior art illustrates development of various tools, techniques, methods for wireless charging of mobile communication devices. However, most of the wireless charging solutions essentially require a base station electrically connected with an electricity outlet, which generally is a stationary component. The existing tools and systems described in the prior art fails to disclose a wireless charging solution for mobile communication devices, which is portable and could be integrated with the mobile communication device case itself, enabling wireless charging of the mobile communication device on the go, eliminating the need of a stationary equipment requirement.

In view of the above mentioned background, it is evident that, there is a need for a case for an electronic device, which could charge the electronic device in wireless manner. There is also a need for a case for an electronic device, which could charge the electronic device in wireless manner, which is portable and could be integrated with the mobile communication device case itself while enabling wireless charging of the mobile communication device on the go, eliminating the need of a stationary equipment requirement. A case for an electronic device is desired.

### BRIEF SUMMARY

Before the present systems and methods, enablement are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application.

In accordance with the present application, the primary objective is to provide acase for an electronic device.

Another objective is to provide a case for an electronic device adapted for charging the electronic device in wireless manner.

Another objective is to provide a case for an electronic device, which is portable and could be integrated with the mobile communication device case itself while enabling wireless charging of the mobile communication device on the go, eliminating the need of a stationary equipment requirement.

Another objective is to provide a case for an electronic device made of suitable materials such that the case can be in compliant with the latest military standards, providing a higher degree of shock protection.

In accordance with one embodiment of the present invention, there is provided a case (100) for an electronic device adapted for charging the electronic device in wireless manner. The case (100) for an electronic device adapted for charging the electronic device in wireless manner comprises of an integrated electronic device charger (102) adapted for charging the electronic device in wireless manner using an integrated sensor adapted to actuate charging of the electronic device when the electronic device reaches below a predefined battery threshold; an auxiliary battery (104) adapted for provided additional power supply to the electronic device; and a charging port (106) adapted for charging the electronic device through external power.

The above invention is provided as a case for an electronic device adapted for charging the electronic device in wireless manner but also can be used for many other applications.

### BRIEF DESCRIPTION OF THE DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1: illustrates a perspective view of a case, in accordance with one embodiment of the present invention;

FIG. 2: illustrates a perspective view of a case with a detached electronic device charger, in accordance with one embodiment of the present invention;

FIG. 3: illustrates a perspective view of a case with a connected electronic device charger, in accordance with one embodiment of the present invention;

FIG. 4: illustrates a sectional view of a case, in accordance with one embodiment of the present invention; and

FIG. 5: illustrates a perspective view of an integrated electronic device charger, in accordance with one embodiment of the present invention.

### DETAILED DESCRIPTION

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

In accordance with one embodiment of the present invention, a case for an electronic device is provided.

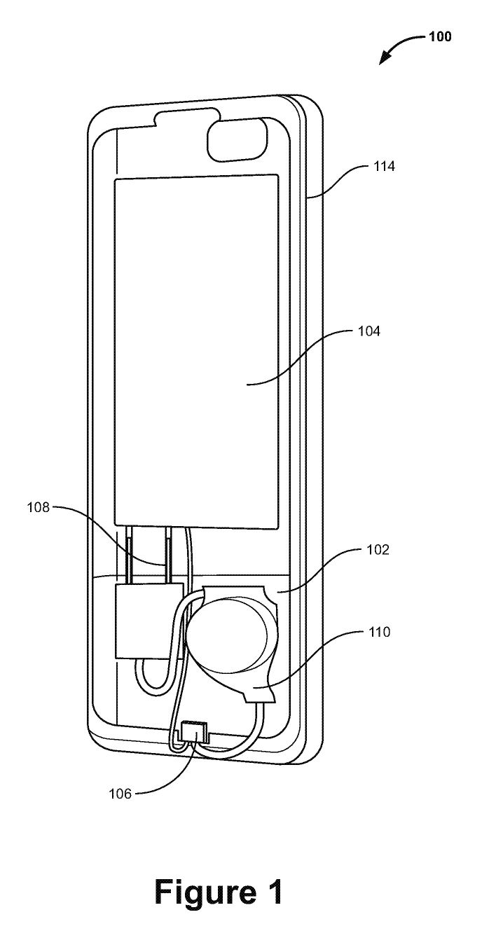

Referring to the FIG. 1 is a perspective view of a case, in accordance with one embodiment of the present invention.

In accordance with one embodiment of the present invention, a case (100) for an electronic device, such as a mobile communication device is provided. The case (100) for an electronic device comprises of an integrated electronic device charger (102); an auxiliary battery (104); and a charging port (106).

In accordance with one embodiment of the present invention, the integrated electronic device charger (102) may be adapted for charging the electronic device in wireless manner using an integrated sensor adapted to actuate charging of the electronic device when the electronic device reaches below a predefined battery threshold. The predefined battery threshold of the electronic device may be 5% of the battery level of the electronic device.

In accordance with an alternative embodiment of the present invention, a switch may be adapted to actuate charging of the electronic device when the electronic device reaches below a predefined battery threshold. The predefined battery threshold of the electronic device may be 5% of the battery level of the electronic device.

In accordance with one embodiment of the present invention, the integrated electronic device charger (102) may be adapted for charging the electronic device in wireless manner and may be a retractable electronic device charger.

In accordance with one embodiment of the present invention, the integrated electronic device charger (102) may further comprise of a pair of flip up plug prongs (108); a retractable coil (110); and a coil retraction button (112). The pair of flip up plug prongs (108) may be connected to the charging port (106) through the retractable coil (110) accommodated therein the integrated electronic device charger (102). The retractable coil (110) accommodated therein the integrated electronic device charger (102) may be adapted to charge other electronic devices compatible to plug in the integrated electronic device charger (102). The retractable coil (110) of the integrated electronic device charger (102) may be retracted using the coil retraction button (112) (not shown in the FIG. 1). The retractable coil (110) of the integrated electronic device charger (102) may come out from bottom of the integrated electronic device charger (102) and may be hidden when the integrated electronic device charger (102) is attached to the case (100) for the electronic device, while retractable coil (110) of the integrated electronic device charger (102) is retracted using the coil retraction button (112) (not shown in the FIG. 1).

In accordance with one embodiment of the present invention, the auxiliary battery (104) may be adapted to provide additional power supply to the electronic device. The auxiliary battery (104) may be connected to the charging port (106).

In accordance with one embodiment of the present invention, the charging port (106) may be adapted for charging the electronic device through external power. The charging port (106) may be connected to auxiliary battery (104). The charging port (106) may be adapted to accommodate a plugin headphone connected through the charging port (106).

In accordance with one embodiment of the present invention, the case (100) may further comprise of a rubber seal (114) at the periphery of the case (100) to hold in the electronic device. The case (100) may further comprise of an interchangeable front side of the case (100) to charge multiple devices.

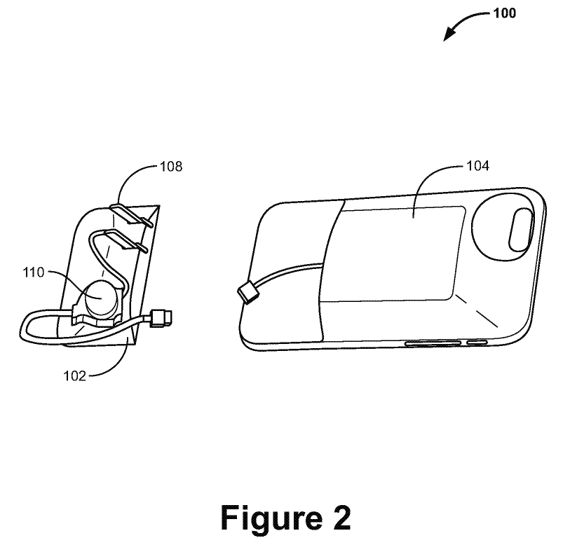

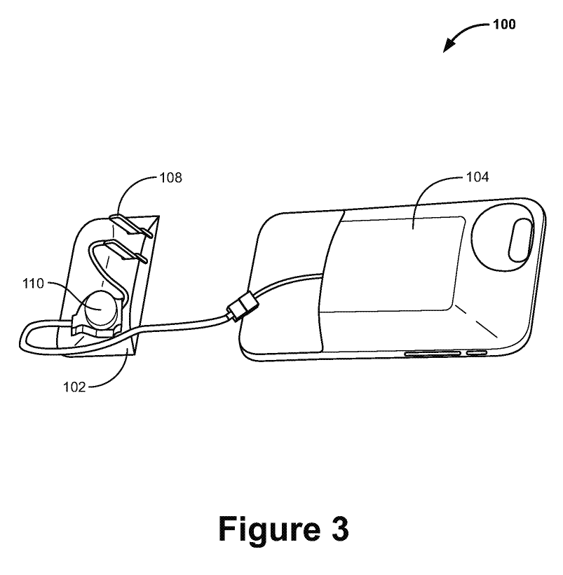

Referring to the FIG. 2 is a perspective view of a case with a detached electronic device charger, in accordance with one embodiment of the present invention; and Referring to the FIG. 3 is a perspective view of a case with a connected electronic device charger, in accordance with one embodiment of the present invention.

In accordance with one embodiment of the present invention, the integrated electronic device charger (102) may be adapted for charging the electronic device in wireless manner using the integrated sensor adapted to actuate charging of the electronic device when the electronic device reaches below a predefined battery threshold. The predefined battery threshold of the electronic device may be 5% of the battery level of the electronic device.

In accordance with one embodiment of the present invention, the integrated electronic device charger (102) may be adapted for charging the electronic device in wireless manner and may be the retractable electronic device charger. The integrated electronic device charger (102) may be detached from the rest of the components of the case (100) for the electronic device according to the FIG. 2. The integrated electronic device charger (102) may be electrically connected with the rest of the components of the case (100) for the electronic device according to the FIG. 3.

In accordance with one embodiment of the present invention, the pair of flip up plug prongs (108) may be connected to the charging port (106) through the retractable coil (110) accommodated therein the integrated electronic device charger (102). The retractable coil (110) accommodated therein the integrated electronic device charger (102) may be adapted to charge a plurality of other electronic devices compatible to plug in the integrated electronic device charger (102). The plurality of other electronic devices may be selected from a group comprising of a mobile phone, a PDA, a smart phone, a feature phone, a smart book, a tablet PC, and a notebook. The retractable coil (110) of the integrated electronic device charger (102) may be retracted using the coil retraction button (112) (not shown in the FIG. 2; and 3). The retractable coil (110) of the integrated electronic device charger (102) may come out from bottom of the integrated electronic device charger (102) and may be hidden when the integrated electronic device charger (102) is attached to the case (100) for the electronic device, while retractable coil (110) of the integrated electronic device charger (102) is retracted using the coil retraction button (112) (not shown in the FIGS. 2; and 3).

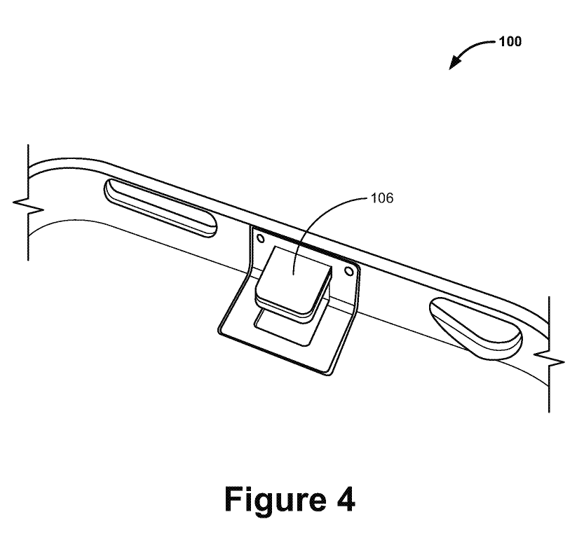

Referring to the FIG. 4 is a sectional view of a case, in accordance with one embodiment of the present invention.

In accordance with one embodiment of the present invention, the case (100) for the electronic device comprises of the charging port (106). The charging port (106) may be adapted for charging the electronic device through external power. The charging port (106) may be connected to auxiliary battery (104) (not shown in the FIG. 4). The charging port (106) may be adapted to accommodate a plugin headphone connected through the charging port (106). The pair of flip up plug prongs (108) (not shown in the FIG. 4) may be connected to the charging port (106) through the retractable coil (110) (not shown in the FIG. 4) accommodated therein the integrated electronic device charger (102) (not shown in the FIG. 4).

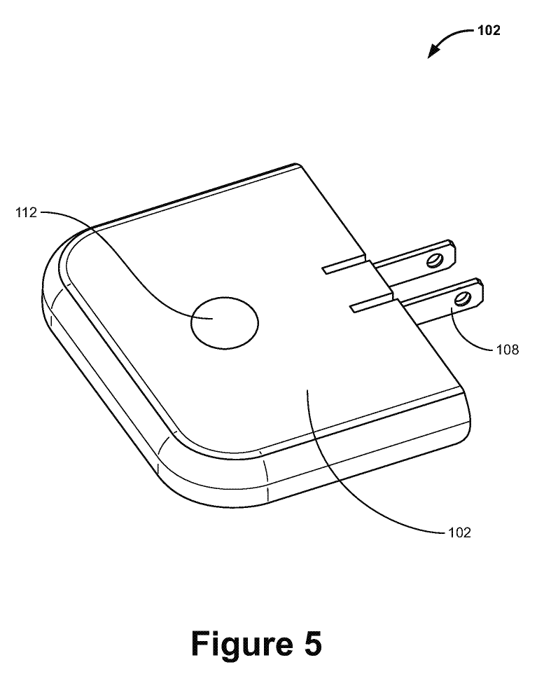

Referring to the FIG. 5 is a perspective view of an integrated electronic device charger, in accordance with one embodiment of the present invention.

In accordance with one embodiment of the present invention, the case (100) for the electronic device is provided comprises of the integrated electronic device charger (102).

In accordance with one embodiment of the present invention, the integrated electronic device charger (102) may be adapted for charging the electronic device in wireless manner using an integrated sensor adapted to actuate charging of the electronic device when the electronic device reaches below a predefined battery threshold. The predefined battery threshold of the electronic device may be 5% of the battery level of the electronic device.

In accordance with an alternative embodiment of the present invention, the switch may be adapted to actuate charging of the electronic device when the electronic device reaches below a predefined battery threshold. The predefined battery threshold of the electronic device may be 5% of the battery level of the electronic device.

In accordance with one embodiment of the present invention, the integrated electronic device charger (102) may be adapted for charging the electronic device in wireless manner and may be a retractable electronic device charger.

In accordance with one embodiment of the present invention, the integrated electronic device charger (102) may further comprise of a pair of flip up plug prongs (108); a retractable coil (110); and a coil retraction button (112). The pair of flip up plug prongs (108) may be connected to the charging port (106) through the retractable coil (110) accommodated therein the integrated electronic device charger (102). The retractable coil (110) accommodated therein the integrated electronic device charger (102) may be adapted to charge other electronic devices compatible to plug in the integrated electronic device charger (102). The retractable coil (110) of the integrated electronic device charger (102) may be retracted using the coil retraction button (112). The retractable coil (110) of the integrated electronic device charger (102) may come out from bottom of the integrated electronic device charger (102) and may be hidden when the integrated electronic device charger (102) is attached to the case (100) for the electronic device, while retractable coil (110) of the integrated electronic device charger (102) is retracted using the coil retraction button (112).

The case (100) for an electronic device may be made of suitable materials such that the case (100) can be in compliant with the latest military standards, providing a higher degree of shock protection.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

The preceding description has been presented with reference to various embodiments. Persons skilled in the art and technology to which this application pertains will appreciate that alterations and changes in the described structures and methods of operation can be practiced without meaningfully departing from the principle, spirit and scope.

What is claimed is:

1. A case (100) for an electronic device; wherein the case (100) comprises of:
a. an integrated electronic device charger (102) adapted for charging the electronic device in wireless manner using an integrated sensor adapted to actuate charging of the electronic device when the electronic device reaches below a predefined battery threshold;
b. an auxiliary battery (104) adapted for providing an additional power supply to the electronic device; and
c. a charging port (106) adapted for charging the electronic device through external power.

2. The case (100) as claimed in claim 1, wherein the predefined battery threshold of the electronic device is 5% of the battery level of the electronic device.

3. The case (100) as claimed in claim 1, wherein the integrated electronic device charger (102) adapted for charging the electronic device in wireless manner is a retractable electronic device charger.

4. The case (100) as claimed in claim 1, wherein the integrated electronic device charger (102) further comprises of a pair of flip up plug prongs (108) connected to the charging port (106) through a retractable coil (110) accommodated therein the integrated electronic device charger (102).

5. The case (100) as claimed in claim 4, wherein the retractable coil (110) accommodated therein the integrated electronic device charger (102) is adapted to charge other electronic devices compatible to plugin the integrated electronic device charger (102).

6. The case (100) as claimed in claim 4, wherein the retractable coil (110) of the integrated electronic device charger (102) is retracted using a coil retraction button (112)

7. The case (100) as claimed in claim 1, wherein the auxiliary battery (104) adapted to provide additional power supply to the electronic device is connected to the charging port (106).

8. The case (100) as claimed in claim 1, further comprises of a plug-in headphone connected with the charging port (106).

9. The case (100) as claimed in claim 1, further comprises of a switch adapted to actuate charging of the electronic device when the electronic device reaches below a predefined battery threshold.

10. The case (100) as claimed in claim 1, further comprises of a rubber seal (114) at the periphery of the case (100) to hold in the electronic device.

11. The case (100) as claimed in claim 1, further comprises of an interchangeable front side of the case (100) to charge multiple devices.
